(19) United States
(12) Patent Application Publication
(10) Pub. No.: US 2014/0265805 A1
(43) Pub. Date: Sep. 18, 2014

(54) APPLIANCE WITH AUTOMATIC DOOR OPENER

(71) Applicant: WHIRLPOOL CORPORATION, Benton Harbor, MI (US)

(72) Inventor: MICHAEL T. CHAMBERLIN, SAINT JOSEPH, MI (US)

(73) Assignee: WHIRLPOOL CORPORATION, Benton Harbor, MI (US)

(21) Appl. No.: 13/832,245

(22) Filed: Mar. 15, 2013

(51) Int. Cl. F25D 23/02; E05F 15/20; F25D 27/00

(52) U.S. Cl. CPC F25D 23/028; F25D 27/005; E05F 15/2023
USPC 312/405; 312/237; 49/31; 49/13

(57) ABSTRACT

A system is provided for automatically opening the doors of appliances such as refrigerators and freezers. In one example, an appliance door handle includes a capacitive touch sensor. When a user touches the touch sensor, visual and audio indicators are activated. After a slight delay, a motor and drive mechanism opens the appliance door.

### FIELD

This disclosure relates to appliances. In particular, this disclosure is drawn to refrigerators and/or freezers having automatic door openers.

### BACKGROUND

When using an appliance such as a refrigerator, users often want to open the refrigerator door while their hands are full of condiments, groceries, leftovers, etc. Without a hand free, the user has to set down the items, open the refrigerator door manually, pick up the items, place the items in the refrigerator, and close the door. In addition, if the user is preparing food, often times, their hands are soiled with the food or ingredients. When manually opening the refrigerator door with soiled hands, the refrigerator door also becomes soiled.

### SUMMARY

A refrigerator is provided including a cabinet, a door providing access to the interior of the cabinet, a motor coupled to the door for opening the door, a handle formed on the door, and a capacitive touch switch formed on the handle for activating the motor when a user touches the capacitive touch switch.

Another embodiment provides a refrigerator including a cabinet, a door coupled to the cabinet, the door having an open position and a closed position, a handle coupled to the door, a motor coupled to the door for moving the door from the closed position to the open position, and a touch switch formed on the handle, wherein the touch switch is electrically coupled to the motor for activating the motor in response to a touch from a user.

Another embodiment provides a refrigerator including a cabinet, a door coupled to the cabinet, the door having an open position and a closed position, a handle coupled to the door, a motor coupled to the door for moving the door from the closed position to the open position, a touch switch formed on the handle of the door, and a controller electrically coupled to the motor and touch switch, the controller including program code for controlling the operation of the motor, wherein the controller activates the motor causing the door to open in response to a user activating the touch switch.

Other features and advantages of the present disclosure will be apparent from the accompanying drawings and from the detailed description that follows below.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a system for automatically opening an appliance door.

FIGS. 2 and 3 are front views of a refrigerator having an automatic door opener.

FIG. 4 is an isometric view of a refrigerator having an automatic door opener.

FIG. 5 is a flowchart illustrating an example of the operation of the operation of an appliance with an automatic door opener.

### DETAILED DESCRIPTION

Generally, the present disclosure relates to an automatic door opener for appliances such as refrigerators and freezers. In one example, an appliance door handle includes a touch sensor. When a user touches the touch sensor, an indicator light illuminates and an audio indicator activates to provide confirmation to the user that the touch sensor was activated, and as a warning that the appliance door is about to open. After a slight delay, a motor and drive mechanism opens the appliance door. The appliance door can be closed manually by the user. In another example, the door can automatically close after a predetermined time, or in response to the user touching the touch sensor again.

An appliance having an automatic door opener can be implemented in any desired manner. Following is a description of an exemplary implementation. Numerous other examples are also possible. FIG. 1 is a block diagram of a system for automatically opening an appliance door. The system uses a microcontroller 10 to control the operation of the door and indicators. The microcontroller 10 is electrically coupled to a motor 14, which is part of an opening mechanism, which may include components such as gears, slip clutches, linkages, etc. The microcontroller 10 controls the motor 14 using any desired components (not shown) such as motor drivers, relays, etc., as one skilled in the art would understand.

The microcontroller 10 is coupled to a touch switch 16 formed on the handle of the appliance. The touch switch may be comprised of a capacitive touch sensor or similar type of sensor. A capacitive switch works using body capacitance. When a user touches the capacitive switch, it changes the capacitance, which can be detected, and triggers the switch. The microcontroller 10 is also coupled to audio and visual indicators (in this example, LED 18 and speaker 20). The microcontroller 10 is programmed to illuminate LED 18 in response to a user touching the touch switch 16. The illumination of the LED 18 provides visual confirmation that the user has activated the touch switch 16. Before opening the door, the microcontroller 10 will activate the speaker 20 to provide an audio warning that the appliance door is about to open. The audio warning allows a user to move away from the door, if the user is in the path of the door. The speaker 20 may be comprised of any desired audio device, such as a piezoelectric speaker. In one example, a piezoelectric speaker provides a soft beep, loud enough to provide an audio warning to someone near the appliance. After the warning beep has been activated for a predetermined amount of time, the microcontroller 10 activates the motor 14 and the opening mechanism to open the appliance door.

The microcontroller 10 is also coupled to other inputs 22, which may include sensors, switches, etc. that provide other information that may be useful in the operation of the automatic door opener. Examples of other inputs include door position sensors, proximity sensors, door interrupt sensors (to detect when something or someone is obstructing the door), etc.

FIGS. 2 and 3 are front views of a refrigerator having an automatic door opener. FIG. 2 shows a front view of a refrigerator 30 with the doors closed. FIG. 3 shows a front view of a refrigerator 30 with one door open. The refrigerator 30 is a side-by-side refrigerator with a freezer compartment 32 on the left, and a fresh food compartment 34 on the right. The freezer compartment 32 has a door 36 and a door handle 38. The fresh food compartment 34 has a door 40 and a door handle 42. Each of the door handles 38 and 42 have a touch sensor 16 formed on the respective handle. In the examples shown, the touch sensors 16 have a generally rectangular shape with curved edges. In other examples, the touch sensors can be formed to cover a substantial portion of the handle, making it easier for a user to touch the sensor. In other examples, multiple touch sensors are formed on the handles, allowing a user to open the door by touching any of the sensors. In the example shown, an LED light 18 is disposed on the handle above the touch sensor 16. In other examples, the LED light (or other visual indicator) can be a part of the refrigerator control panel 44. A speaker 20 (e.g., a piezoelectric device) is shown (using dashed lines) behind the overlay surface of the control panel 44.

An appliance and automatic door opener described herein can use any desired motor and door opening mechanism desired, as one skilled in the art would understand. A typical door opening mechanism may include a motor, a gear transmission, a slip clutch, etc. The door opening mechanism is designed to ensure that the door will stop opening upon striking an obstacle to prevent striking a person, or to prevent damage to the door opening mechanism. The door opening mechanism also allows a user to manually open and close the doors. If desired, the door opening mechanism includes primary and secondary mechanisms. A primary mechanism is what moves the door from the closed position to the opened position. In some configurations, the second mechanism may be desired to break the seal of the door, caused by a vacuum and the magnetic door latch.

FIGS. 2 and 3 show opening mechanisms 46 and 48 for opening the doors 40 and 36, respectively. Each opening mechanism 46 and 48 includes a motor and the desired gear transmissions, clutches, etc. The opening mechanism 46 and 48 may also include secondary mechanisms to provide the force needed to break the seal of the doors, if needed. The opening mechanisms shown in the example of FIGS. 2 and 3 are located near the top hinges of the doors. In other examples, the opening mechanisms can be located near the bottom hinges, or at some location between the hinges. In other examples, the opening mechanisms may include components at more than one location (e.g., at both hinges).

FIG. 4 is an isometric view of a refrigerator 50 having an automatic door opener. The refrigerator 50 shown in FIG. 4 functions generally the same as the refrigerator 30 shown in FIG. 2, but is a top-bottom refrigerator, rather than a side-by-side. Similar components of the refrigerator 50 will use the same reference numerals as those in FIG. 2. The refrigerator 50 has an upper freezer compartment 32, and a lower fresh food compartment 34. The freezer compartment 32 has a door 36 and a door handle 38. The fresh food compartment 34 has a door 40 and a door handle 42. Each of the door handles 38 and 42 have a touch sensor 16 formed on the respective handle. An LED light 18 is disposed on the handle above the touch sensor 16. A speaker 20 (e.g., a piezoelectric device) is shown (using dashed lines) behind the overlay surface of the control panel 44.

FIG. 4 shows opening mechanisms 46 and 48 for opening the doors 40 and 36, respectively. Each opening mechanism 46 and 48 includes a motor and the desired gear transmissions, clutches, etc. The opening mechanism 46 and 48 may also include secondary mechanisms to provide the force needed to break the seal of the doors, if needed. The opening mechanisms shown in the example of FIG. 4 are located near one of the hinges of each door.

FIG. 5 is a flowchart illustrating an example of the operation of the operation of an appliance with an automatic door opener. The operation of the appliance will be described in the context of a refrigerator, such as the refrigerators shown in FIGS. 2 and 4. At step 5-10, a user touches the touch switch. Once the microcontroller senses that the touch switch has been activated, the visual indicator is illuminated (step 5-12) to notify the user that the switch was activated. At the same time, the audio alarm is activated to provide a warning that the refrigerator door is about to open (step 5-14). After a short delay (step 5-16), the motor is activated (step 5-18), opening the refrigerator door.

In the preceding detailed description, the disclosure is described with reference to specific exemplary embodiments thereof. Various modifications and changes may be made thereto without departing from the broader spirit and scope of the disclosure as set forth in the claims. The specification and drawings are, accordingly, to be regarded in an illustrative rather than a restrictive sense.

What is claimed is:

1. A refrigerator comprising:
a cabinet;
a door providing access to the interior of the cabinet;
a motor coupled to the door for opening the door;
a handle formed on the door; and
a capacitive touch switch formed on the handle for activating the motor when a user touches the capacitive touch switch.

2. The refrigerator of claim 1, further comprising an indicator light, wherein the indicator light is illuminated in response to a user activating the capacitive touch switch.

3. The refrigerator of claim 2, wherein the indicator light is integrated with the handle.

4. The refrigerator of claim 1, further comprising an audio device, wherein the audio device is triggered in response to a user activating the capacitive touch switch.

5. The refrigerator of claim 4, wherein the audio device is triggered prior to activating the motor.

6. The refrigerator of claim 1, further comprising delay circuitry for delaying the activation of the motor after a user touches the capacitive touch switch.

7. A refrigerator comprising:
a cabinet;
a door coupled to the cabinet, the door having an open position and a closed position;
a handle coupled to the door;
a motor coupled to the door for moving the door from the closed position to the open position; and
a touch switch formed on the handle, wherein the touch switch is electrically coupled to the motor for activating the motor in response to a touch from a user.

8. The refrigerator of claim 7, wherein the touch switch is a capacitance touch switch.

9. The refrigerator of claim 7, further comprising an indicator light formed on the refrigerator, wherein the indicator light is illuminated in response to a user touching the touch switch.

10. The refrigerator of claim 9, wherein the indicator light is integrated with the handle.

11. The refrigerator of claim 7, further comprising an audio signaling device, wherein the audio signaling device is activated in response to a user touching the touch switch.

12. The refrigerator of claim 10, wherein the audio signaling device is triggered prior to activating the motor.

13. The refrigerator of claim 7, further comprising delay circuitry coupled to the motor for delaying the activation of the motor after the touch switch is touched by a user.

14. A refrigerator comprising:
a cabinet;
a door coupled to the cabinet, the door having an open position and a closed position;
a handle coupled to the door;
a motor coupled to the door for moving the door from the closed position to the open position;
a touch switch formed on the handle of the door; and
a controller electrically coupled to the motor and touch switch, the controller including program code for controlling the operation of the motor, wherein the controller activates the motor causing the door to open in response to a user activating the touch switch.

15. The refrigerator of claim 14, wherein the touch switch is a capacitance touch switch.

16. The refrigerator of claim 14, wherein the controller delays the opening of the door for a first duration after the user activates the touch switch.

17. The refrigerator of claim 14, further comprising an indicator light electrically coupled to the controller, wherein the controller triggers the indicator light in response to a user activating the touch switch.

18. The refrigerator of claim 14, further comprising a piezoelectric element electrically coupled to the controller, wherein the controller triggers the piezoelectric element in response to a user activating the touch switch.
